(19) United States
(12) Patent Application Publication
(10) Pub. No.: US 2024/0389624 A1
(43) Pub. Date: Nov. 28, 2024

(54) EGG COAGULATION PROMOTER

(71) Applicant: FUJI OIL HOLDINGS INC., Osaka (JP)

(72) Inventor: Sho YAMASHITA, Ibaraki (JP)

(21) Appl. No.: 18/669,871

(22) Filed: May 21, 2024

(30) Foreign Application Priority Data
May 22, 2023 (JP) 2023-083911

(51) Int. Cl. A23L 15/00

(52) U.S. Cl. CPC A23L 15/20

(57) ABSTRACT

Provided are an egg coagulation promoter including a water-soluble polysaccharide containing galacturonic acid derived from beans, a method for producing the same, and a method for promoting egg coagulation using the egg coagulation promoter. Specifically, provided is an egg coagulation promoter including a water-soluble polysaccharide containing galacturonic acid derived from beans, the polysaccharide being a water-soluble soybean polysaccharide or water-soluble pea polysaccharide.

### CROSS-REFERENCE TO RELATED APPLICATION

This application claims priority from Japanese Patent Application No. 2023-083911 filed with the Japan Patent Office on May 22, 2023, the entire content of which is hereby incorporated by reference.

### BACKGROUND

### 1. Technical Field

The present disclosure relates to an egg coagulation promoter.

### 2. Related Art

In recent years, demand for precooked foods has been increasing. In particular, egg processed products produced in large quantities in dedicated factories are sold at convenience stores and supermarkets. In addition, many consumers have come to use the egg processed products that are cooked in large quantities at one time at hotels and restaurants. In the egg processed products that are distributed and marketed, particular problems are texture of eggs and shortening of producing and cooking times.

Conventionally, the eggs are hardened using heat coagulability of their proteins. Alternatively, the eggs may be hardened using a gelling agent such as gelatin. The eggs cooked in this manner are industrially produced as the egg processed products (JP-A-2008-125447 and JP-A-2001-037446).

### SUMMARY

The egg coagulation promoter according to an embodiment of the present disclosure includes a water-soluble polysaccharide containing galacturonic acid derived from beans.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Generally, when using heat coagulability of eggs, quality of egg processed products may not be stable due to raw materials other than eggs such as milk raw materials, seasoning liquid, or ingredients, or due to variations in heating. Therefore, it is not possible to obtain desired hardness as the egg processed product. As a result, a problem has arisen that quality cannot be established. Further, it requires a long time for heat coagulation. Therefore, a problem has also arisen that mass production is hindered.

As a result, in order to establish stable quality of the egg processed product, we are in an environment where we have no choice but to rely on gelling agents such as gelatin or agar, or modified starches rather than using the heat coagulability of the egg. However, it is not desirable to create texture without utilizing heat coagulation ability of the egg, because an original flavor or texture of the egg will be greatly impaired.

In order to improve the heat coagulation ability of the egg, a dried egg is subjected to heat storage treatment. The heat storage treatment increases gel strength of the egg. Therefore, the heat storage treatment is generally essential for many dried egg products. However, the cost of the dried egg is high. Further, its distribution volume is small. Therefore, it is difficult to use large quantities of dried eggs. Further, liquid egg products with a large distribution volume cannot be subjected to the heat storage treatment. Therefore, there is a problem that the heat coagulation ability cannot be improved.

Further, as a technique for producing egg materials for egg processed foods using water-soluble hemicellulose, JP-A-2000-189112 describes that the egg is coagulated by pouring a beaten egg containing hemicellulose into hot water of 95° C. or higher. However, effects on the egg processed products produced by heating at a lower temperature are unknown.

An object of the present embodiment is to provide an egg coagulation promoter that promotes egg coagulation in a relatively low temperature range and improves quality of a resulting egg processed product.

As a result of intensive studies to solve the above problems, it was discovered that a water-soluble polysaccharide containing galacturonic acid derived from beans promotes egg coagulation and provides egg processed products with good quality. Thus, the egg coagulation promoter of the present embodiment was completed.

That is, the present embodiment relates to the following egg coagulation promoter, method for producing an egg processed food, and method for promoting egg coagulation.
(1) An egg coagulation promoter including a water-soluble polysaccharide containing galacturonic acid derived from beans.
(2) The egg coagulation promoter according to (1), in which the water-soluble polysaccharide containing galacturonic acid derived from beans is water-soluble soybean polysaccharide or water-soluble pea polysaccharide.
(3) A method for producing an egg processed food, the method including the following steps (A) to (C).
   a step (A) of preparing a water-soluble polysaccharide containing galacturonic acid derived from beans
   a step (B) of mixing the water-soluble polysaccharide and a raw material containing eggs
   a step (C) of heating a mixture obtained in the step (B)

However, in the step (B), the water-soluble polysaccharide is added in an amount of 0.5 mass % or more and 250 mass % or less based on protein of the eggs.
(4) The method for producing the egg processed food according to (3), in which heating temperature is below 95° C. in the step (C).
(5) A method for promoting egg coagulation during production of egg processed food, the method including the following steps (a) to (c).
   a step (a) of preparing a water-soluble polysaccharide containing galacturonic acid derived from beans
   a step (b) of mixing the water-soluble polysaccharide and a raw material containing eggs a step (c) of heating a mixture obtained in the step (b)

However, in the step (b), the water-soluble polysaccharide is added in an amount of 0.5 mass % or more and 250 mass % or less based on protein of the eggs.
(6) The method for promoting egg coagulation according to (5), in which heating temperature is below 95° C. in the step (c).

By using the egg coagulation promoter including the water-soluble polysaccharide containing galacturonic acid derived from beans of the present embodiment, the egg coagulation is promoted and the egg processed products with good quality can be obtained.

### (Egg Coagulation Promoter)

The egg coagulation promoter of the present embodiment includes the water-soluble polysaccharide containing galacturonic acid derived from beans.

By using the egg coagulation promoter of the present embodiment during production of egg processed food, the egg coagulation can be promoted. Therefore, the egg processed food of excellent quality can be efficiently produced.

In the present embodiment, promotion of the egg coagulation means that in an egg coagulation test described below, whole egg, egg yolk, or egg white to which the water-soluble polysaccharide containing galacturonic acid derived from beans is added has shorter coagulation time than the whole egg, egg yolk, or egg white without additives. The coagulation time of the whole egg, egg yolk, or egg white to which the water-soluble polysaccharide containing galacturonic acid derived from beans is added is preferably reduced by 5% or more, and more preferably 10% or more compared to that of the whole egg, egg yolk, or egg white without additives.

Further, the egg coagulation promoter of the present embodiment can promote the egg coagulation. At the same time, conditions of coagulated egg processed products including size, elasticity, and hardness of egg coagulum are good. Further, for example, since there is no syneresis of the egg processed product, its quality is also good. In this regard, when another thickening polysaccharide is used, the coagulation time may not be shortened. Alternatively, even when the coagulation time is shortened, quality of the coagulum may not be satisfactory. As described above, the egg coagulation promoter including the water-soluble polysaccharide containing galacturonic acid derived from beans of the present embodiment is excellent in terms of the quality of the egg coagulum.

Further, in the present embodiment, the egg coagulation promoter is more effective when heated over a certain amount of time in a temperature range lower than a boiling temperature or higher.

From this point of view, a temperature (a coagulation promotion temperature) at which the coagulation is promoted by the egg coagulation promoter of the present embodiment is preferably lower than 95° C., and more preferably 90° C. or lower. Further, a lower limit temperature is preferably 50° C. or higher, and more preferably 55° C. or higher. The coagulation promotion temperature can also be 60° C. or higher or 65° C. or higher.

Further, a heating time is preferably 5 minutes or more, and more preferably 8 minutes or more. The heating time can also be 10 minutes or more, 12 minutes or more, or 15 minutes or more. Further, an upper limit of the heating time is preferably 120 minutes or less, and more preferably 100 minutes or less. The upper limit of the heating time can also be 90 minutes or less, 80 minutes or less, or 70 minutes or less.

Content of the water-soluble polysaccharide containing galacturonic acid derived from beans used in the egg coagulation promoter of the present embodiment is preferably 50 mass % or more, and more preferably 60 mass % or more based on solid content. The content can be 70 mass % or more, 75 mass % or more, 80 mass % or more, 85 mass % or more, 90 mass % or more, 95 mass % or more, or 100 mass %.

The form of the egg coagulation promoter of the present embodiment is not particularly limited. The egg coagulation promoter can be used in the form of liquid, powder, or granule.

The egg coagulation promoter of the present embodiment can be appropriately used in combination with other additives within a range that does not impair its effects. Examples of the other additives include: monosaccharides including sugar, glucose, and fructose; oligosaccharides including sucrose, maltose, lactose, raffinose, maltotriose, trehalose, stachyose, and maltotetraose; sweeteners including sugar alcohol, high-fructose corn syrup, starch syrup, reduced starch syrup, oligosaccharide, reduced oligosaccharide, honey, sucralose, aspartame, and stevia; animal and vegetable oils including rapeseed oil, corn oil, cottonseed oil, safflower oil, olive oil, safflower oil, soybean oil, palm oil, fish oil, and egg yolk oil, or their refined oils (salad oils); edible fats and oils such as fats and oils obtained by chemical treatment, enzymatic treatment, or the like, including medium chain fatty acid triglyceride (MCT), diglyceride, hydrogenated oil, and interesterified oil; seasonings including salts, table salt, soy sauce, pepper, amino acid, calcium chloride, and nucleic acid; organic acids including acetic acid, citric acid, lactic acid, adipic acid, gluconic acid, tartaric acid, succinic acid, and malic acid; acidulants such as ascorbic acid; moist heat treated starch; modified starch; antioxidants such as vitamin E; and pigments.

(Water-Soluble Polysaccharide Containing Galacturonic Acid Derived from Beans)

Examples of raw materials for the water-soluble polysaccharide containing galacturonic acid derived from beans in the present embodiment include soybean, adzuki bean, mung bean, cowpea, red kidney bean, flower bean, kidney bean, butter bean, fava bean, pea, chickpea, locust bean, sword bean, lupine bean, lentil, and peanut. Particularly preferable examples of the water-soluble polysaccharide containing galacturonic acid derived from beans used in the present embodiment include water-soluble pea polysaccharide and water-soluble soybean polysaccharide. Two or more of exemplified water-soluble polysaccharide containing galacturonic acid derived from beans can also be used in combination.

### (Water-Soluble Pea Polysaccharide)

The water-soluble pea polysaccharide in the present embodiment refers to a water-soluble polysaccharide extracted from pea seeds. The water-soluble pea polysaccharide extracted from a fruiting part of the pea seeds is preferred. More preferred is the water-soluble pea polysaccharide extracted from yellow pea seeds. As a production method thereof, the water-soluble pea polysaccharide can be obtained, for example, by a production example described in the specification of WO 2012/176852. An example of the product is “FIPEA-D” (produced by Fuji Oil Co., Ltd.).

### (Water-Soluble Soybean Polysaccharide)

The water-soluble soybean polysaccharide in the present embodiment refers to a water-soluble polysaccharide extracted from soybean seeds. The water-soluble soybean polysaccharide extracted from a fruiting part of the soybean seeds is preferred. More preferred is the water-soluble soybean polysaccharide extracted from okara produced as a by-product when producing, for example, tofu or isolated soybean protein. It is still more preferred to use okara obtained from defatted soybean. An example of a production method thereof is a method of extracting the water-soluble soybean polysaccharide from raw material okara under alkaline or weakly acidic conditions at a temperature above 100° C., preferably 150° C. or lower, and more preferably 130° C. or lower. The water-soluble soybean polysaccharide contained in an extraction solvent is obtained from a mixture of the extraction solvent and the raw material by solid-liquid separation. Examples of the trade name include “Soya Five-S” (produced by Fuji Oil Co., Ltd.).

### (Egg Processed Food)

In the present embodiment, examples of the egg processed food include pudding, chawanmushi, omelet, and dashimaki tamago (omelet made with broth).

### (Method for Producing Egg Processed Food)

The method for producing the egg processed food of the present embodiment will be described below with reference to examples.

The egg coagulation promoter including the water-soluble polysaccharide containing galacturonic acid derived from beans, and a raw material such as egg are mixed. The egg processed food is obtained by heating the resulting mixture. The egg processed food can also be obtained by mixing an aqueous solution obtained by dissolving the egg coagulation promoter in, for example, water or milk in advance with the raw material such as egg, and then heating the resulting mixture.

Various raw materials can be used to produce the egg processed food in addition to the whole egg, egg yolk, egg white, and the coagulation promoter of the present embodiment. Examples of the raw materials include: milk, monosaccharides including sugar, glucose, and fructose; oligosaccharides including sucrose, maltose, lactose, raffinose, maltotriose, trehalose, stachyose, and maltotetraose; sweeteners including sugar alcohol, high-fructose corn syrup, starch syrup, reduced starch syrup, oligosaccharide, reduced oligosaccharide, honey, sucralose, aspartame, and stevia; animal and vegetable oils including rapeseed oil, corn oil, cottonseed oil, safflower oil, olive oil, safflower oil, soybean oil, palm oil, fish oil, and egg yolk oil, or their refined oils (salad oils); edible fats and oils such as fats and oils obtained by chemical treatment, enzymatic treatment, or the like, including medium chain fatty acid triglyceride (MCT), diglyceride, hydrogenated oil, and interesterified oil; seasonings including salts, table salt, soy sauce, pepper, amino acid, calcium chloride, nucleic acid and dashi (Japanese broth); organic acids including acetic acid, citric acid, lactic acid, adipic acid, gluconic acid, tartaric acid, succinic acid, and malic acid; acidulants such as ascorbic acid; moist heat treated starch; modified starch; antioxidants such as vitamin E; and pigments.

The egg coagulation promoter including the water-soluble polysaccharide containing galacturonic acid derived from beans is preferably added in an amount of 0.5 to 250 mass % as the water-soluble polysaccharide containing galacturonic acid derived from beans based on mass of the protein of the eggs. More preferably, a lower limit of addition amount based on the mass of the protein of the eggs can be 1 mass % or more, 1.5 mass % or more, 2 mass % or more, or 2.5 mass % or more. Further, more preferably, an upper limit of the addition amount can be 230 mass % or less, 200 mass % or less, 150 mass % or less, 100 mass % or less, 95 mass % or less, or 90 mass % or less.

Further, the heating temperature is preferably lower than 95° C., and more preferably 90° C. or lower. Further, the lower limit temperature is preferably 50° C. or higher, and more preferably 55° C. or higher. The heating temperature can be 60° C. or higher or 65° C. or higher.

Further, the heating time is preferably 5 minutes or more, and can be more preferably 8 minutes or more, 10 minutes or more, 12 minutes or more, or 15 minutes or more. Further, the upper limit of the heating time is preferably 120 minutes or less, and more preferably 100 minutes or less. The upper limit of the heating time can be 90 minutes or less, 80 minutes or less, or 70 minutes or less.

### Examples and Comparative Examples

The present embodiment will be explained with reference to Examples and Comparative Examples described below. Note that % in the examples means “mass %” unless otherwise specified.

The water-soluble polysaccharide used as the egg coagulation promoter in Examples and Comparative Examples are as follows.
Water-soluble soybean polysaccharide: “Soyafive-S-DA100” (produced by Fuji Oil Co., Ltd.)
Water-soluble pea polysaccharide: “FIPEA-D” (produced by Fuji Oil Co., Ltd.)
Dextrin: Maldek PH400P (produced by Showa Sangyo Co., Ltd.)
HM pectin: GENU pectin type YM-115-LJ (produced by Sansho Co., Ltd.)
Gum Arabic: Arabic Call SS (produced by San-Ei Yakuhin Boeki Co., Ltd.)
Pullulan: (produced by Hayashibara Co., Ltd.)
Gelatin: New Silver Granule (produced by Nitta Gelatin Inc.)

### (Test for Promoting Egg Coagulation on Whole Egg)

In Examples and Comparative Examples, degree of egg coagulation promotion was tested using the following method.

Raw materials mixed in formulations shown in Table 1 were heated at 72° C. for 60 minutes. Thus, the egg coagulum was obtained. Note that viscosity of the mixed raw materials during heating was measured using a rotational viscometer (RheolabQC, Yamato Scientific Co., Ltd.), coaxial cylinder type Peltier temperature control system, coaxial cylinder measurement system CC27/QC-LTD, and vane type measurement system (ST24-2D/2V/2V-30/109 (custom-made)) at a stirring speed of 100 rpm. The heating temperature was increased to a specified temperature (60° C. or 72° C.) over 10 minutes under heating conditions. After the heating temperature reached the specified temperature, the specified temperature was maintained for 60 minutes. The viscosity was measured every 4 seconds while the temperature was maintained. When a decrease in value of the viscosity was observed in three consecutive measurements, it was determined that the coagulation was completed. A time required from the heating temperature reaching the specified temperature to completion of the coagulation was defined as the coagulation time.

Further, for the resulting egg coagulum, the condition of the egg coagulum and syneresis of the egg coagulum were evaluated according to the following criteria. The results are shown in Table 1. Note that a protein content of the whole egg was 12.2%.

### (Evaluation of Egg Coagulum)

### 1. Condition of Egg Coagulum

2 points: A lump of the egg coagulum is observed.

The egg coagulum is elastic and does not collapse easily even when pressed strongly.

1 point: A lump of the egg coagulum is observed.

Although the egg coagulum has elasticity, it easily collapses when pressed strongly.

0 points: There are many small granules in the egg coagulum. The egg coagulum does not have much elasticity and easily collapses when pressed.

−1 point: There are many small granules in the egg coagulum. Since the egg coagulum has no elasticity, it cannot be grasped with fingers.

### 2. Syneresis of Egg Coagulum

1 point: No syneresis is observed.

0 point: A small amount of moisture is generated on a bottom surface of a measuring device due to syneresis.

−1 point: Since most of fresh water in the mixture undergoes syneresis, a large amount of moisture due to syneresis is observed on a bottom surface of a container after taking out the egg coagulum.

TABLE 1

| | Heating (72° C. × 60 min) | | | | | | |
|---|---|---|---|---|---|---|---|
| | Exam- | Exam- | Comparative | Comparative | Comparative | Comparative | Comparative |
| Formulation (%) | ple 1 | ple 2 | Example 1 | Example 2 | Example 3 | Example 4 | Example 5 |
| Whole egg | 90.0 | 90.0 | 90.0 | 90.0 | 90.0 | 90.0 | 90.0 |
| Water-soluble soybean polysaccharide | 0.5 | 1.0 | — | — | — | — | — |
| Dextrin | — | — | — | 1.0 | — | — | — |
| HM pectin | — | — | — | — | 1.0 | — | — |
| Gum arabic | — | — | — | — | — | 1.0 | — |
| Pullulan | — | — | — | — | — | — | 1.0 |
| Water | 9.5 | 9.0 | 10.0 | 9.0 | 9.0 | 9.0 | 9.0 |
| Total | 100 | 100 | 100 | 100 | 100 | 100 | 100 |
| Addition ratio of polysaccharide | 4.6 | 9.1 | — | 9.1 | 9.1 | 9.1 | 9.1 |
| to protein content of egg (%) | | | | | | | |
| Time required for coagulation (min) | 22.9 | 20.7 | 24.7 | 27.1 | 16.1 | 21.0 | 17.3 |
| Coagulation shortening time (min) | 1.8 | 4.0 | — | −2.4 | 8.6 | 3.7 | 7.4 |
| Shortening rate of coagulation time | 7.3 | 16.2 | — | −10.5 | 34.8 | 15.0 | 30.0 |
| to no additive (%) | | | | | | | |
| Condition of coagulum (point) | 1 | 2 | — | −1 | −1 | 1 | −1 |
| Syneresis of coagulum (point) | 1 | 1 | — | −1 | −1 | 0 | −1 |
| Comprehensive evaluation of coagulum | B | A | — | D | D | C | D |

(*) Comprehensive evaluation of egg coagulum

When the total score of an evaluation score of the condition of the egg coagulum and an evaluation score of the syneresis was 3 points, the egg coagulum was evaluated as A. When the total score was 2 points, the egg coagulum was evaluated as B. When the total score was 1 point, the egg coagulum was evaluated as C. When the total score was 0 or less, the egg coagulum was evaluated as D. When comprehensive evaluation was A or B, the egg coagulum was determined to be pass.

From the results shown in Table 1, it was confirmed that when the water-soluble soybean polysaccharide was used, a coagulation promoting effect of the whole egg was excellent, and the quality of the egg coagulum was also good.

### (Egg Coagulation Promotion Test for Egg Yolk)

Raw materials mixed in formulations shown in Table 2 were heated at 72° C. for 60 minutes. Thus, the egg coagulum was obtained. The egg coagulum was evaluated using the same method as in Example 1. The results are shown in Table 2. Note that the protein content of the egg yolk was 16.5%.

TABLE 2

| | Heating (72° C. × 60 min) | | |
|---|---|---|---|
| | Comparative | Example | Example |
| Formulation (%) | Example 6 | 3 | 4 |
| Egg yolk | 90.0 | 90.0 | 90.0 |
| Water-soluble soybean | — | 0.5 | 1.0 |
| polysaccharide | | | |
| Water | 10.0 | 9.5 | 9.0 |
| Total | 100 | 100 | 100 |
| Addition ratio of | — | 3.4 | 6.7 |
| polysaccharide to protein | | | |
| content of egg (%) | | | |
| Time required for | 50.9 | 44.9 | 37.3 |
| coagulation (min) | | | |
| Coagulation shortening | — | 6.0 | 13.6 |
| time (min) | | | |
| Shortening rate of | — | 11.8 | 26.7 |
| coagulation time to no | | | |
| additive (%) | | | |
| Condition of coagulum | — | 2 | 2 |
| (point) | | | |
| Syneresis of coagulum | — | 1 | 1 |
| (point) | | | |
| Comprehensive | — | A | A |
| evaluation of coagulum | | | |

(*) Comprehensive evaluation of egg coagulum

When the total score of an evaluation score of the condition of the egg coagulum and an evaluation score of the syneresis was 3 points, the egg coagulum was evaluated as A. When the total score was 2 points, the egg coagulum was evaluated as B. When the total score was 1 point, the egg coagulum was evaluated as C. When the total score was 0 or less, the egg coagulum was evaluated as D. When comprehensive evaluation was A or B, the egg coagulum was determined to be pass.

From the results shown in Table 2, it was confirmed that when the water-soluble soybean polysaccharide was used, even in the egg yolk, the coagulation promoting effect was excellent, and the quality of the egg coagulum was also good.

### (Egg Coagulation Promotion Test for Egg White)

Raw materials mixed in formulations shown in Table 3 were heated at 60° C. for 60 minutes. Thus, the egg coagulum was obtained. The results are shown in Table 3. Note that the protein content of the egg white was 10.1%.

TABLE 3

| | Heating (60° C. × 60 min) | |
|---|---|---|
| | Comparative | Example |
| Formulation (%) | Example 7 | 5 |
| Egg yolk | 90.0 | 90.0 |
| Water-soluble soybean | — | 0.5 |
| polysaccharide | | |
| Water | 10.0 | 9.5 |
| Total | 100 | 100 |
| Addition ratio of | — | 5.5 |
| polysaccharide to | | |
| protein content of egg | | |
| (%) | | |
| Time required for | 2.3 | 2.0 |
| coagulation (min) | | |
| Coagulation shortening | — | 0.3 |
| time (min) | | |
| Shortening rate of | — | 13.0 |
| coagulation time to | | |
| no additive (%) | | |

From the results in Table 3, it was also confirmed that by using the water-soluble soybean polysaccharide, the coagulation of the egg white was promoted.

### (Coagulation Promotion Test in Pudding)

Coagulation promotion in pudding was evaluated by a method described below.

Based on formulations in Table 4, raw materials including whole egg, milk, water-soluble soybean polysaccharide, and fresh water were mixed using a magnetic stirrer. After removing bubbles from the mixture, a 50 mL conical tube (material: polypropylene) was filled with 40 g of the mixture. Ten samples added with the water-soluble soybean polysaccharide (Example 6) and ten samples without addition of water-soluble soybean polysaccharide (Comparative Example 8) were prepared. These samples were placed in a constant temperature water bath at 90° C., and then heated for 2, 4, 6, 8, 10, 12, 14, 16, 18, or 20 minutes. Thereafter, the samples were cooled to 20° C. using ice water. Thus, puddings for testing were obtained.

After removing a cap of the conical tube, the conical tube was turned upside down and held for 1 minute. When the pudding inside did not fall out within 1 minute, a shortest heating time among heating times of the samples was defined as the coagulation time. The results are shown in Table 4.

TABLE 4

| | Comparative | Example |
|---|---|---|
| Formulation (%) | Example 8 | 6 |
| Water-soluble soybean | — | 0.5 |
| polysaccharide | | |
| Milk | 40.0 | 40.0 |
| Whole egg | 20.0 | 20.0 |
| Water | 40.0 | 38.5 |
| Total | 100 | 100 |
| Addition ratio of | — | 20.5 |
| polysaccharide to protein | | |
| content of egg (%) | | |
| Time required for | 12 | 8 |
| coagulation (min) | | |
| Coagulation shortening | — | 4 |
| time (min) | | |
| Shortening rate of | — | 33.3 |
| coagulation time to no | | |
| additive (%) | | |

As shown in the results in Table 4, in Example 6 in which the water-soluble soybean polysaccharide was added, it was confirmed that the coagulation was promoted.

### (Examination 1 of Increasing Rate of Breaking Load and Increasing Rate of Breaking Deformation in Pudding)

Whether the pudding to which the coagulation promoter of the present embodiment was added had good physical properties was checked by measuring an increasing rate of breaking load and an increasing rate of breaking deformation.

Based on formulations in Tables 5-1 to 5-3, raw materials including the whole egg, milk, various polysaccharides, and fresh water were mixed using a magnetic stirrer. After removing the bubbles that had formed in the mixture, a pudding cup was filled with 70 g of the mixture. The pudding cup was heated at 90° C. for 20 minutes under conditions of the above 100% and wind speed level 2 using a combination oven (iCombiPro manufactured by RATIONAL). Thereafter, the pudding cup was cooled to obtain the puddings for testing. The increasing rate of the breaking load and the increasing rate of the breaking deformation of each pudding were evaluated by a method described below. The results are shown in Table 5-1 (Comparative Example 9, Examples 7 to 16), Table 5-2 (Comparative Examples 10 to 16), and Table 5-3 (Comparative Examples 17 to 24).

### (Evaluation of Increasing Rate of Breaking Load and Increasing Rate of Breaking Deformation)

The breaking load and the breaking deformation of each pudding were measured using Leonar II manufactured by Yamaden Co., Ltd.

Measurement conditions are as follows.

A f12 mm ball was used. A thickness of the samples was 30 mm. The sample was pushed into a measuring apparatus by 60% of its thickness. A plunger speed was 60 mm/min.

The increasing rate of the breaking load and the increasing rate of the breaking deformation for pudding without addition of polysaccharide were calculated by a formula described below.

### Increasing Rate of Breaking Load

The breaking load (unit: gf) in Examples and Comparative Examples is an index indicating how much force is required for the pudding to break. As this value is larger, the pudding is evaluated to be harder and firmer.

When the increasing rate of the breaking load was 105% or more, the pudding was determined to be pass. The increasing rate of the breaking load is preferably 110% or more.

$$Increasing rate of breaking load ( \% ) = ( Breaking load of pudding added with polysaccharide ) / ( Breaking load of pudding without addition of polysaccharide ) \times 100$$

### Increasing Rate of Breaking Deformation

Further, the breaking deformation (unit: mm) in Examples and Comparative Examples is an index indicating how far the pudding was pushed before it broke. It is evaluated whether the pudding added with polysaccharide has the same properties as the pudding without addition of polysaccharide. When the breaking deformation is extremely large, the pudding has properties similar to gelatin pudding and is therefore determined to be unfavorable.

When the increasing rate of the breaking deformation was 90% to 150%, the pudding was determined to be pass. The increasing rate of the breaking deformation is preferably 95% to 140%.

$$Increasing rate of breaking deformation ( \% ) = ( Breaking deformation of pudding added with polysaccharide ) / ( Breaking deformation of pudding without addition of polysaccharide ) \times 100$$

TABLE 5-1

| | Comparative | Exam- | Exam- | Exam- | Exam- | Exam- | Exam- | Exam- | Exam- | Exam- | Exam- |
|---|---|---|---|---|---|---|---|---|---|---|---|
| Formulation (%) | Example 9 | ple 7 | ple 8 | ple 9 | ple 10 | ple 11 | ple 12 | ple 13 | ple 14 | ple 15 | ple 16 |
| Whole egg | 20 | 20 | 20 | 20 | 20 | 20 | 20 | 20 | 20 | 20 | 20 |
| Milk | 40 | 40 | 40 | 40 | 40 | 40 | 40 | 40 | 40 | 40 | 40 |
| Water-soluble soybean polysaccharide | — | 0.3 | 0.5 | 0.7 | 1.0 | 2.0 | — | — | — | — | — |
| Water-soluble pea polysaccharide | — | — | — | — | — | — | 0.3 | 0.5 | 0.7 | 1.0 | 2.0 |
| Water | 40 | 39.7 | 39.5 | 39.3 | 39.0 | 38.0 | 39.7 | 39.5 | 39.3 | 39.0 | 38.0 |
| Total | 100 | 100 | 100 | 100 | 100 | 100 | 100 | 100 | 100 | 100 | 100 |
| Addition ratio of polysaccharide | — | 12.3 | 20.5 | 28.7 | 41.0 | 82.0 | 12.3 | 20.5 | 28.7 | 41.0 | 82.0 |
| to protein content of egg (%) | | | | | | | | | | | |
| Increasing rate of breaking load | — | 156 | 178 | 200 | 163 | 111 | 120 | 142 | 179 | 163 | 167 |
| (%) | | | | | | | | | | | |
| Increasing rate of breaking | — | 121 | 133 | 130 | 116 | 111 | 112 | 121 | 127 | 118 | 110 |
| deformation (%) | | | | | | | | | | | |
| Physical properties of pudding | — | pass | pass | pass | pass | pass | pass | pass | pass | pass | pass |

TABLE 5-2

| | Comparative | Comparative | Comparative | Comparative | Comparative | Comparative | Comparative |
|---|---|---|---|---|---|---|---|
| Formulation (%) | Example 10 | Example 11 | Example 12 | Example 13 | Example 14 | Example 15 | Example 16 |
| Whole egg | 20 | 20 | 20 | 20 | 20 | 20 | 20 |
| Milk | 40 | 40 | 40 | 40 | 40 | 40 | 40 |
| HM pectin | 0.01 | 0.04 | 0.20 | 1.00 | — | — | — |
| Dextrin | — | — | — | — | 0.5 | 1.0 | 2.0 |
| Water | 39.99 | 39.96 | 39.8 | 39.0 | 39.5 | 39.0 | 38.0 |
| Total | 100 | 100 | 100 | 100 | 100 | 100 | 100 |
| Addition ratio of polysaccharide | 0.4 | 1.6 | 8.2 | 41.0 | 20.5 | 41.0 | 82.0 |
| to protein content of egg (%) | | | | | | | |
| Increasing rate of breaking load | 101 | 87 | 73 | 36 | 86 | 84 | 91 |
| (%) | | | | | | | |
| Increasing rate of breaking | 102 | 92 | 72 | 78 | 96 | 95 | 99 |
| deformation (%) | | | | | | | |
| Physical properties of pudding | fail | fail | fail | fail | fail | fail | fail |

TABLE 5-3

| | Comparative | Comparative | Comparative | Comparative | Comparative | Comparative | Comparative | Comparative |
|---|---|---|---|---|---|---|---|---|
| Formulation (%) | Example 17 | Example 18 | Example 19 | Example 20 | Example 21 | Example 22 | Example 23 | Example 24 |
| Whole egg | 20 | 20 | 20 | 20 | 20 | 20 | 20 | 20 |
| Milk | 40 | 40 | 40 | 40 | 40 | 40 | 40 | 40 |
| Gum arabic | 0.5 | 1.0 | 2.0 | — | — | — | — | — |
| Gelatin | — | — | — | 1.5 | 2.5 | — | — | — |
| Pullulan | — | — | — | — | — | 0.25 | 0.5 | 1.0 |
| Water | 39.5 | 39.0 | 38.0 | 38.5 | 37.5 | 39.75 | 39.5 | 39.0 |
| Total | 100 | 100 | 100 | 100 | 100 | 100 | 100 | 100 |
| Addition ratio of polysaccharide | 20.5 | 41.0 | 82.0 | 61.5 | 102.5 | 10.2 | 20.5 | 41.0 |
| to protein content of egg (%) | | | | | | | | |
| Increasing rate of breaking load | 95 | 85 | 100 | 67 | 267 | 94 | 103 | 55 |
| (%) | | | | | | | | |
| Increasing rate of breaking | 116 | 106 | 115 | 187 | 254 | 92 | 101 | 92 |
| deformation (%) | | | | | | | | |
| Physical properties of pudding | fail | fail | fail | fail | fail | fail | fail | fail |

As shown in Tables 5-1 to 5-3, in Examples 7 to 16 using the water-soluble soybean polysaccharide or the water-soluble pea polysaccharide, it was confirmed that puddings having a good increasing rate of the breaking load and a good increasing rate of the breaking deformation could be prepared. Further, the puddings obtained in Examples were good, and no syneresis was observed. On the other hand, in Comparative Examples 10 to 24 using other polysaccharides or gelatin, the increasing rate of the breaking load and the increasing rate of the breaking deformation were unfavorable.

### (Examination 2 of Increasing Rate of Breaking Load and Increasing Rate of Breaking Deformation in Pudding) Examination of Heating Time

Puddings were prepared in the same manner as in Example 8, except that raw materials listed in Table 6 were used, the heating temperature was 85° C., and the heating time was 15 to 60 minutes, and evaluated. The results are shown in Table 6.

TABLE 6

| | | | | | Increasing |
|---|---|---|---|---|---|
| | | Com- | | Increasing | rate of |
| | | parative | | rate of | breaking |
| | | Example | Example | breaking | deformation |
| Formulation (%) | | 25 | 17 | load (%) | (%) |
| Water-soluble soybean | | — | 0.5 | — | |
| polysaccharide | | | | | |
| Milk | | 57.5 | 57.5 | | |
| Granulated sugar | | 12.5 | 12.5 | | |
| Whole egg | | 25.0 | 25.0 | | |
| Water | | 5.0 | 4.5 | | |
| Total | | 100 | 100 | | |
| Addition ratio of | | — | 16.4 | | |
| polysaccharide to | | | | | |
| protein content of | | | | | |
| egg (%) | | | | | |
| Breaking | 85° C. × 15 min | 42.8 | 50.7 | 118% | — |
| load (gf) | 85° C. × 20 min | 47.9 | 54.3 | 113% | — |
| | 85° C. × 30 min | 51.2 | 60.2 | 117% | — |
| | 85° C. × 45 min | 61.9 | 68.3 | 110% | — |
| Breaking | 85° C. × 15 min | 11.5 | 12.3 | — | 107% |
| de- | 85° C. × 20 min | 11.6 | 11.5 | — | 99% |
| formation | 85° C. × 30 min | 11.4 | 11.3 | — | 100% |
| (mm) | 85° C. × 45 min | 11.6 | 11.5 | | 99% |

| | | |
|---|---|---|
| Physical properties of | — | pass |
| padding | | |

In Examples using the water-soluble soybean polysaccharide, the puddings having a good increasing rate of the breaking load and a good increasing rate of the breaking deformation could be prepared. Further, the puddings obtained in Examples were good, and no syneresis was observed.

### (Coagulation Promotion Test in Dashimaki Tamago)

In Examples and Comparative Examples, the coagulation promotion of the dashimaki tamago was evaluated by a test using the following method.

Raw materials mixed in formulations shown in Table 7 were heated at 72° C. for 60 minutes. Thus, the dashimaki tamago was obtained. Note that viscosity of the mixed raw materials during heating was measured using a rotational viscometer (RheolabQC, Yamato Scientific Co., Ltd.), coaxial cylinder type Peltier temperature control system, coaxial cylinder measurement system CC27/QC-LTD, and vane type measurement system (ST24-2D/2V/2V-30/109 (custom-made)) at a stirring speed of 100 rpm. The heating temperature was increased to a 72° C. over 10 minutes under heating conditions. After the heating temperature reached the specified temperature, the specified temperature was maintained for 60 minutes. The viscosity was measured every 4 seconds while the temperature was maintained. When a decrease in value of the viscosity was observed in three consecutive measurements, it was determined that the coagulation was completed. A time required from the heating temperature reaching the specified temperature to completion of the coagulation was defined as the coagulation time.

Further, for the resulting dashimaki tamago, the condition of the dashimaki tamago and syneresis of the dashimaki tamago were evaluated according to the following criteria. The results are shown in Table 7.

### (Evaluation of Dashimaki Tamago)

### 1. Condition of Dashimaki Tamago

2 points: A lump of the dashimaki tamago is observed.

The dashimaki tamago is elastic and does not collapse easily even when pressed strongly.

1 point: A lump of the dashimaki tamago is observed.

Although the dashimaki tamago has elasticity, it easily collapses when pressed strongly.

0 points: There are many small granules in the dashimaki tamago. The dashimaki tamago does not have much elasticity and easily collapses when pressed.

−1 point: There are many small granules in the dashimaki tamago. Since the dashimaki tamago has no elasticity, it cannot be grasped with fingers.

### 2. Syneresis of Dashimaki Tamago

1 point: No syneresis is observed.

0 point: A small amount of moisture is generated on a bottom surface of a measuring device due to syneresis.

−1 point: Since most of fresh water in the mixture undergoes syneresis, a large amount of moisture due to syneresis is observed on a bottom surface of a container after taking out the dashimaki tamago.

### (*) Comprehensive Evaluation of Dashimaki Tamago

When the total score of an evaluation score of the condition of the dashimaki tamago and an evaluation score of the syneresis was 3 points, the dashimaki tamago was evaluated as A. When the total score was 2 points, the dashimaki tamago was evaluated as B. When the total score was 1 point, the dashimaki tamago was evaluated as C. When the total score was 0 or less, the dashimaki tamago was evaluated as D. When comprehensive evaluation was A or B, the dashimaki tamago was determined to be pass.

TABLE 7

| | Heating (72° C. × 60 min) | | |
|---|---|---|---|
| | Comparative | Example | Example |
| Formulation (part) | Example 26 | 18 | 19 |
| Water-soluble soybean | — | 0.75 | 1.5 |
| polysaccharide | | | |
| Kappo Shirodashi | 12.5 | 12.5 | 12.5 |
| Whole egg | 100 | 100 | 100 |
| Water | 37.5 | 36.75 | 36.0 |
| Total | 150 | 150 | 150 |
| Addition ratio of polysaccharide | — | 6.1 | 12.3 |
| to protein content of egg (%) | | | |
| Time required for coagulation | 26.7 | 24.2 | 20.9 |
| (min) | | | |
| Coagulation shortening time | — | 2.5 | 5.8 |
| (min) | | | |
| Shortening rate of coagulation | — | 9.4 | 21.7 |
| time to no additive (%) | | | |
| Condition of dashimaki | — | 1 | 2 |
| tamago (point) | | | |
| Syneresis of dashimaki tamago | — | 1 | 1 |
| (point) | | | |
| Comprehensive evaluation | — | B | A |
| of dashimaki tamago | | | |

As shown in the results in Table 7, it was confirmed that the coagulation was promoted in Examples 18 and 19 in which the water-soluble soybean polysaccharide was added. It was also found that quality of the dashimaki tamago was good.

### (Examination of Increasing Rate of Breaking Load and Increasing Rate of Breaking Deformation in Dashimaki Tamago)

Whether the dashimaki tamago to which the coagulation promoter of the present embodiment was added had good physical properties was checked by measuring the increasing rate of the breaking load and the increasing rate of the breaking deformation. Measurements were performed according to the following procedure.
1. Raw materials shown in Table 8 were mixed using a magnetic stirrer. An octagon rotor (38 mm×f8 mm, 300 rpm) was used for mixing. This provided a slurry for cooking. Note that as a raw material “dashi”, “Kappo Shirodashi (Dashi based liquid seasonings)” manufactured by Yamaki Co., Ltd. was used.
2. Dashimaki tamago was cooked using a frying pan for fried egg.
   A frying pan in which 5 g of rapeseed oil was placed was heated over medium heat.
   After ⅓ of the slurry was poured into the frying pan, the frying pan was heated until a temperature of product reached approximately 85° C.
   After the slurry was rolled, the rapeseed oil was placed on the frying pan again. Thereafter, ⅓ of the slurry was poured into the frying pan. The frying pan was heated until the temperature of the product reached approximately 85° C.
   After the slurry was rolled, rest of the slurry was cooked in the same way.
3. Using Leonar II manufactured by Yamaden Co., Ltd., the breaking load and the breaking deformation of “dashimaki tamago cut into 3 cm piece” were measured. Measurement conditions were as follows.
   A wedge with a width of 30 mm was used. The thickness of the sample was 18 mm. The sample was pushed into the measuring apparatus by 100% of its thickness. The plunger speed was 60 mm/min.

The results are shown in Table 8.

Note that the protein content of the whole egg was 12.2%.

### Increasing Rate of Breaking Load

The breaking load (unit: gf) in Examples and Comparative Examples is an index indicating how much force is required for the dashimaki tamago to break. As this value is larger, the dashimaki tamago is evaluated to be harder and firmer.

When the increasing rate of the breaking load was 105% or more, the dashimaki tamago was determined to be pass. The increasing rate of the breaking load is preferably 110% or more.

Increasing rate of the breaking load (%)=(Breaking load of dashimaki tamago added with polysaccharide)/(Breaking load of dashimaki tamago without addition of polysaccharide)×100

### Increasing Rate of Breaking Deformation

Further, the breaking deformation (unit: mm) in Examples and Comparative Examples is an index indicating how far the dashimaki tamago was pushed before it broke. It is evaluated whether the dashimaki tamago added with polysaccharide has the same properties as the dashimaki tamago without addition of polysaccharide.

When the increasing rate of the breaking deformation was 90% to 150%, the dashimaki tamago was determined to be pass. The increasing rate of the breaking deformation is preferably 95% to 140%.

Increasing rate of breaking deformation (%)=(Breaking deformation of dashimaki tamago added with polysaccharide)/(Breaking deformation of dashimaki tamago without addition of polysaccharide)×100

TABLE 8

| | | | | Increasing |
|---|---|---|---|---|
| | Com- | | Increasing | rate of |
| | parative | | rate of | breaking |
| | Example | Example | breaking | deformation |
| Formulation (part) | 27 | 20 | load (%) | (%) |
| Water-soluble soybean | — | 0.75 | — | |
| polysaccharide | | | | |
| Dashi | 12.5 | 12.5 | | |
| Whole egg | 100.0 | 100.0 | | |
| Water | 37.5 | 36.75 | | |
| Total | 150.0 | 150.0 | | |
| Addition ratio of | — | 6.1 | | |
| polysaccharide to protein | | | | |
| content of egg (%) | | | | |
| Breaking load (gf) | 159.8 | 182.9 | 114% | — |
| Breaking deformation (mm) | 10.1 | 11.3 | — | 112% |

| | | |
|---|---|---|
| Physical properties of | — | pass |
| dashimaki tamago | | |

As shown in Table 8, results showing a good increasing rate of the breaking load and a good increasing rate of the breaking deformation were also obtained for the dashimaki tamago.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An egg coagulation promoter comprising a water-soluble polysaccharide containing galacturonic acid derived from beans.

2. The egg coagulation promoter according to claim 1, wherein the water-soluble polysaccharide containing galacturonic acid derived from beans is water-soluble soybean polysaccharide or water-soluble pea polysaccharide.

3. A method for producing an egg processed food, the method comprising:
a step (A) of preparing a water-soluble polysaccharide containing galacturonic acid derived from beans;
a step (B) of mixing the water-soluble polysaccharide and a raw material containing egg; and
a step (C) of heating a mixture obtained in the step (B), wherein
in the step (B), the water-soluble polysaccharide is added in an amount of 0.5 mass % or more and 250 mass % or less based on protein of the egg.

4. The method for producing the egg processed food according to claim 3, wherein the mixture is heated below 95° C. in the step (C).

5. A method for promoting egg coagulation in producing an egg processed food, the method comprising:
a step (a) of preparing a water-soluble polysaccharide containing galacturonic acid derived from beans;
a step (b) of mixing the water-soluble polysaccharide and a raw material containing egg; and
a step (c) of heating a mixture obtained in the step (b), wherein
in the step (b), the water-soluble polysaccharide is added in an amount of 0.5 mass % or more and 250 mass % or less based on protein of the egg.

6. The method for promoting egg coagulation in producing the egg processed food according to claim 5, wherein the mixture is heated below 95° C. in the step (c).
